(19) United States
(12) Patent Application Publication
(10) Pub. No.: US 2016/0182866 A1
(43) Pub. Date: Jun. 23, 2016

(54) SELECTIVE HIGH FRAME RATE VIDEO CAPTURING IN IMAGING SENSOR SUBAREA

(71) Applicant: Sony Corporation, Tokyo (JP)

(72) Inventors: Magnus Landqvist, Lund (SE); Alexander Hunt, Tygelsjo (SE); Peter Isberg, Lund (SE); Ola Thörn, Limhamn (SE); Linus Mårtensson, Lund (SE)

(21) Appl. No.: 14/576,495

(22) Filed: Dec. 19, 2014

(51) Int. Cl. H04N 7/18

(52) U.S. Cl. CPC H04N 7/183

(57) ABSTRACT

Video data is captured by an imaging sensor. Motion is detected in the captured video data, e.g., by applying image analysis to different video frames of the captured video data. At least one subarea of an overall imaging area of the imaging sensor is determined. The subarea is determined to correspond to a position of the detected motion. In the determined subarea, a video capturing frame rate applied which is higher than a video capturing frame rate applied in other parts of the overall imaging area.

### FIELD OF THE INVENTION

The present invention relates to a method of capturing video and to a correspondingly configured device.

### BACKGROUND OF THE INVENTION

Various kinds of electronic devices, e.g., smartphones, tablet computers, or digital cameras, also support capturing of video. For this purpose such a device may be equipped with an imaging sensor, e.g., based on CCD (Charge Coupled Device) or CMOS (Complementary Metal Oxide Semi-conductor) technology. A typical frame rate of capturing video is in the range of 20 frames per second to 60 frames per second. Utilizing a higher frame rate may provide a higher quality of the captured video, e.g., by avoiding blurring of objects moving at high speed. In some scenarios, even higher frame rates of capturing video may be desirable, e.g., when recording slow motion video.

However, utilization of higher frames rates typically also comes at the cost of increased resource utilization, e.g., with respect to energy required for readout of the imaging sensor or memory required for storing the acquired image data. Capturing video data at both high frame rate and high resolution is therefore a demanding task.

Accordingly, there is a need for techniques which allow for efficiently capturing high quality video.

### SUMMARY OF THE INVENTION

According to an embodiment of the invention, a method of capturing video is provided. According to the method, video data is captured by an imaging sensor, e.g., a sensor based on an array of pixels, such as a CCD image sensor or a CMOS image sensor. Motion is detected in the captured video data, e.g., by applying image analysis to different video frames of the captured video data. At least one subarea of an overall imaging area of the imaging sensor is determined. The subarea is determined to correspond to a position of the detected motion. In the determined subarea, a video capturing frame rate applied set which is higher than a video capturing frame rate in other parts of the overall imaging area. The video capturing frame rate applied in the subarea may be increased by at least a factor of two with respect to the video capturing frame rate in the other parts of the overall imaging area. For example, if the video capturing frame rate in the other parts of the overall imaging area is in a range of 20 frames per second to 60 frames per second, the higher video capturing frame rate applied in the subarea may be 200 frames per second to 1000 frames per second.

According to an embodiment, the above-mentioned capturing of the video data comprises capturing a first video frame and a second video frame which cover the overall imaging area and, in a time interval between capturing the first video frame and capturing the second video frame, capturing a sequence of one or more further video frames covering only the determined subarea.

According to an embodiment, the method further comprises combining each of said one or more further video frames with at least one of the first video frame and the second video frame to a corresponding intermediate video frame covering the overall imaging area.

According to an embodiment, the above-mentioned detecting of motion is based on the one or more further video frames. In addition, the detecting of motion may also consider the above-mentioned first video frame and/or second video frame. The detecting of motion may comprise identifying at least one moving object represented by the captured video data.

According to an embodiment, the above-mentioned determining of the subarea comprises, for each of the one or more further subframes, predicting a position of the moving object and determining the subarea to cover the moving object in the respective further subframe.

According to an embodiment, the above-mentioned determining of the subarea comprises predicting a position of the moving object and determining the subarea to cover the moving object in all of the further subframes.

The above-mentioned determining of the subarea may involve setting a size of the subarea and/or a position of the subarea in the overall imaging area.

According to an embodiment, the above-mentioned, the method further comprises detecting global motion of the imaging sensor. This may be accomplished on the basis of the captured video data and/or on the basis of one or more motion sensors. In response to detecting motion of the imaging sensor, the higher video capturing frame rate may be applied in all parts of the overall imaging area, and a pixel resolution of capturing the video data in the overall imaging area may be reduced.

According to a further embodiment of the invention, a device is provided. The device comprises an imaging sensor, e.g., a sensor based on an array of pixels, such as a CCD image sensor or a CMOS image sensor. Further, the device comprises at least one processor. The at least one processor is configured to capture video data by the imaging sensor. Further, the at least one processor is configured to detect motion on the basis of the captured video data. Further, the at least one processor is configured to determine at least one subarea of an overall imaging area of the imaging sensor, which corresponds to a position of the detected motion. Further, the at least one processor is configured to apply, in the determined subarea, a video capturing frame rate which is higher than a video capturing frame rate applied in other parts of the overall imaging area.

The at least one processor may be configured to perform steps of the method according to the above embodiments.

Accordingly, the at least one processor may be configured to capture the video data by capturing a first video frame and a second video frame which cover the overall imaging area and, in a time interval between capturing the first video frame and capturing the second video frame, capturing a sequence of one or more further video frames covering only the determined subarea.

Further, the at least one processor may be configured to combine each of said one or more further video frames with at least one of the first video frame and the second video frame to an corresponding intermediate video frame covering the overall imaging area.

Further, the at least one processor may be configured to perform the above-mentioned detecting of motion based on the one or more further video frames.

Further, the at least one processor may be configured to perform the above-mentioned detecting of motion by identifying at least one moving object represented by the captured video data.

Further, the at least one processor may be configured to perform the above-mentioned determining of the subarea by, for each of the one or more further subframes, predicting a position of the moving object and determining the subarea to cover the moving object in the respective further subframe.

Further, the at least one processor may be configured to perform the above-mentioned determining of the subarea by predicting a position of the moving object and determining the subarea to cover the moving object in all of the further subframes.

Further, the at least one processor may be configured to detect global motion of the imaging sensor and, in response to detecting motion of the imaging sensor, apply the higher video capturing frame rate in all parts of the overall imaging area and reduce a pixel resolution of capturing the video data in the overall imaging area. The at least one processor may be configured to detect the global motion on the basis of the captured video data and/or on the basis of one or more motion sensors.

The above and further embodiments of the invention will now be described in more detail with reference to the accompanying drawings.

### BRIEF DESCRIPTION OF THE DRAWINGS

FIG. 1 schematically illustrates a device according to an embodiment of the invention.

FIG. 2 schematically illustrates a scenario of operating an imaging sensor according to an embodiment of the invention.

FIG. 3 shows a flowchart for illustrating a method according to an embodiment of the invention.

FIG. 4 schematically illustrates a processor based implementation of a device according to an embodiment of the invention.

### DETAILED DESCRIPTION OF EMBODIMENTS

In the following, exemplary embodiments of the invention will be described in more detail. It has to be understood that the following description is given only for the purpose of illustrating the principles of the invention and is not to be taken in a limiting sense. Rather, the scope of the invention is defined only by the appended claims and is not intended to be limited by the exemplary embodiments described hereinafter.

The illustrated embodiments relate to capturing video by an imaging sensor. The imaging sensor may include a pixel array for spatially resolved detection of light emitted from an imaged scene. The imaging sensor may for example be based on CCD or CMOS technology. On the one hand, normal video frames covering an overall imaging area of the imaging sensor are captured at a base frame rate of video capturing, typically utilizing a full pixel resolution of the imaging sensor. Further, additional video frames covering only a subarea of the imaging area are captured at a higher frame rate of video capturing, i.e., at a frame rate which is higher than the base frame rate. This may be achieved by capturing a sequence of the additional video frames in a time interval between capturing two subsequent normal video frames. Depending on the number of the additional video frames in the sequence, the video capturing frame rate is increased by a corresponding factor (e.g., one additional video frame between the two subsequent normal video frames corresponding to a factor of two, two additional video frames between the two subsequent normal video frames corresponding to a factor of three, etc.). By limiting the capturing at the higher frame rate to only the subarea, excessive resource utilization can be avoided.

In the illustrated embodiments, the subarea is determined on the basis of motion as detected in the captured video data. In particular, the position and/or size of the subarea may be determined to match with the position and/or size of a moving object detected in the captured video data. Accordingly, the higher frame rate may be applied in portions of the overall imaging area where it is necessary to achieve high quality imaging of a moving object.

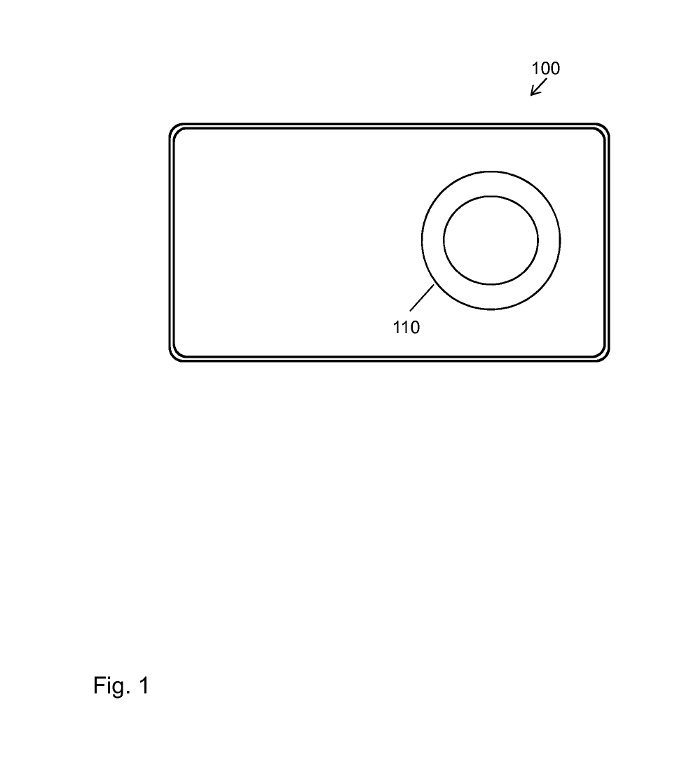

FIG. 1 schematically illustrates a device 100. In the example of FIG. 1, the user device 100 is assumed to be a smartphone, a tablet computer, or digital camera (e.g., a compact camera, a system camera, a camcorder, an action cam, or a life-log camera). As illustrated, the device 100 is equipped with a camera 110, which in turn is equipped with the above-mentioned imaging sensor (not shown in FIG. 1). The camera 110 is assumed to support for capturing digital video at high resolution, e.g., at “Full HD” resolution of 1920×1080 pixels or even higher resolution, such as “Ultra HD” resolution of 3840×2160 pixels or even 7680×4320 pixels. Further the camera 110 is assumed to support utilization of different frame rates of video capturing in different parts of its imaging area. For example, in most parts of the imaging area the base frame rate of video capturing may be applied. The base frame rate may for example correspond to 24, 30, 50, or 60 frames per second. In one or more subareas of the imaging area, a higher frame rate of video capturing may be applied, e.g., in the range of 100 to 1000 frames per second. As mentioned above, the position and/or size of this subarea may be controlled depending on motion detected in the captured video data.

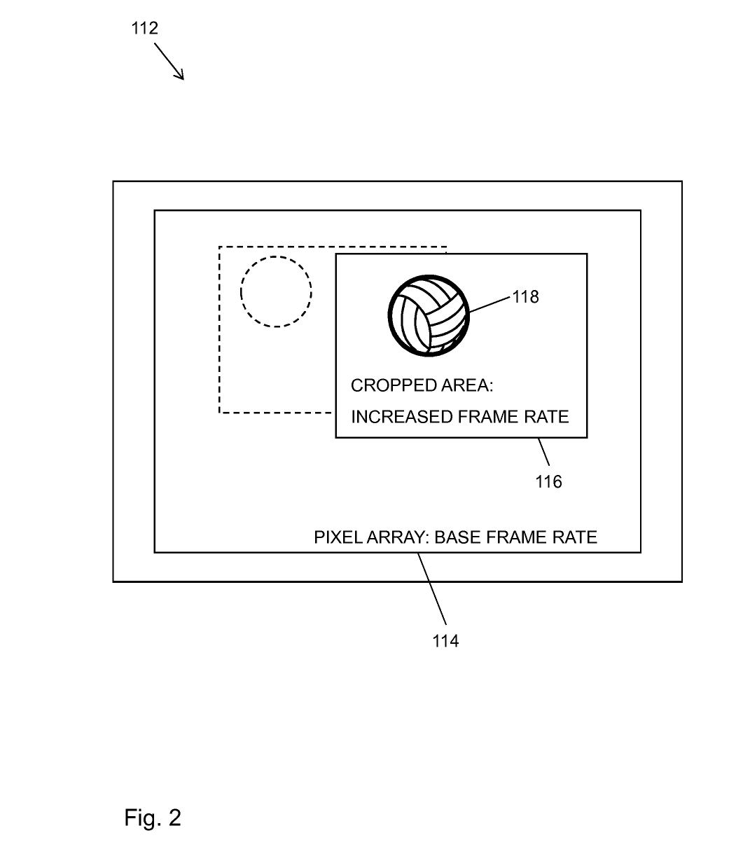

FIG. 2 schematically illustrates an exemplary imaging sensor 112 which may be used in the camera 110 and an exemplary scenario of controlling the position and/or size of the subarea. As illustrated, the imaging sensor 112 includes a pixel array 114 which defines the overall imaging area of the imaging sensor 112. Further, FIG. 2 illustrates the subarea 116 in which the higher frame rate of video capturing is applied. In the remaining portions of the overall imaging area the base frame rate of video capturing is applied. The position and/size of the subarea 116 when capturing an earlier video frame is illustrated by dashed lines. Further, FIG. 2 schematically illustrates a moving object 118 represented by the captured video data.

As can be seen from the illustration of FIG. 2, from the earlier video frame to the present video frame the moving object 118 changed its position within the overall imaging area. Further, e.g., due to the moving object 118 moving towards or away from the camera, also the apparent size of the moving object 118 may have changed. The characteristics of this motion of the moving object 118 may be determined and be used to estimate the position and/or size of the moving object 118 in future video frames. As illustrated in FIG. 2, the subarea 116 is shifted and resized in a corresponding manner.

Accordingly, in the illustrated embodiments the detected motion in the captured image may be utilized to predict and set suitable sizes of the subarea 116 in which the higher frame rate of video capturing is applied. In some scenarios, also the higher frame rate itself could be adjusted, e.g., depending on a detected speed of motion of the moving object 118.

As mentioned above, the higher frame rate may be obtained by capturing the additional video frames only in the subarea, whereas the normal video frames are captured at the base frame rate and cover the overall imaging area of the imaging sensor 112. A high frame rate video may then be generated from the normal video frames and intermediate video frames combining the additional video frames with one or more of the preceding or subsequent normal video frames. For generating such intermediate video frames, the video data corresponding to the detected moving object 118 or the video data of the entire additional video frame may be blended into the normal video frame(s). In some cases, also interpolation of video data from two subsequent video frames may be performed to generate an interpolated video frame, and the video data corresponding to the detected moving object 118 or the video data of the entire additional video frame may be blended into the interpolated video frame.

The detection of motion in the captured video data may involve performing image analysis and comparisons between subsequent video frames. This image analysis may be applied on the basis of the normal video frames and/or on the basis of the additional video frames. Here, it should be noted that, due to the higher frame rate of video capturing, taking into account the additional video frames offers higher accuracy, responsiveness, and sensitivity for the detection of motion.

The detection of motion may be performed over the course of a limited number of subsequent video frames, e.g., of three video frames. For example, first a normal video frame may be captured. On the basis of the normal video frame, an initial estimate of present motion may be performed, e.g., by detecting potentially blurred areas.

Assuming that a potentially blurred area is identified in the first video frame, the subarea may be set to cover this blurred area, and a second video frame, corresponding to one of the additional video frames, may be captured at the higher frame rate to cover only the subarea. By comparison and image analysis of the first video frame and the second video frame, the detection of motion can be refined. In particular, it can be determined whether there is a moving object, such as the moving object 118, and the moving object may the identified with respect to its shape. Further, also the motion of the moving object may be characterized, e.g., in terms of a motion vector indicating speed and direction of motion. The determined characteristics of motion of the moving object may then be utilized to predict its position and/or size in the next video frame to be captured and to adjust the position and/or size of the subarea correspondingly. Then the next video frame, i.e., a third video frame, is captured to cover only the adjusted subarea. The third video frame may then be utilized for further refining the detection of motion, e.g., by comparison and image analysis of the first video frame, the second video frame, and the third video frame. The motion of the moving object may thus be further characterized and be applied for further adjustments of the subarea as applied for capturing further additional video frames.

The image analysis and comparison may for example involve computing an image difference, thresholding to avoid noise, and determination of an area potentially including a moving object depending on the image difference. Then, one or more object detection algorithms may be applied in such area. For example, a distributed histogram-based object detection algorithm as described in “HISTOGRAM-BASED SEARCH: A COMPARATIVE STUDY” by Sizintsev et al., IEEE Conference on Computer Vision and Pattern Recognition (2008) may be applied for this purpose. Depending on the higher frame rate applied in the subarea, this may allow for detecting and quantifying motion within a time window of less than 16 ms, e.g., in about 2 ms.

It is to be understood that also multiple moving objects represented by the captured video data may be considered in this way, e.g., by determining a corresponding subarea with the higher video capturing frame rate for each of these moving objects or by determining the same subarea in such a way that it allows for covering all these multiple moving objects.

Further, in some scenarios it may be desirable to avoid changing the size and/or shape of the subarea between the individual additional video frames, e.g., in order to avoid changes in settings with respect to anti aliasing. The size and/or shape of the subarea may then be determined in such a way that it covers the position of the moving object in all relevant additional video frames, i.e., in video frames in which the moving object is expected to be visible. However, new sizes of the subarea may be selected from time to time, e.g., when capturing one of the normal video frames or when detecting a new moving object.

Further, it should be noted that a maximum size of the subarea may be limited by the characteristics of the imaging sensor 112. For example, if the imaging sensor supports certain maximum video capturing frame rate at full pixel resolution represented by a full number of pixels, and the additional video frames are captured at a video capturing frame rate which corresponds to X times this maximum video capturing frame rate at full resolution, the size of the subarea may be limited to a maximum number of pixels corresponding to the full number of pixels divided by the factor X. In this way, it becomes possible to utilize similar parameters for readout of the pixels, e.g., with respect to integration time, both when capturing the normal video frames and when capturing the additional video frames.

In some scenarios, also global motion of the imaging sensor 112 itself may be considered, e.g., due to panning movements, vibration, or shaking of the image sensor 112. If such global motion is detected, it may be utilized as an additional input in the process of identifying the moving object and characterizing its motion, e.g., by compensating effects of the global motion. For this purpose, various kinds of image stabilization algorithms may be applied to the captured video frames (normal frames and/or additional frames). As an alternative or in addition, the device 100 may also be equipped with one or more motion sensors, such as accelerometers. The output of such motion sensors may be applied for physically counteracting the motion of the imaging sensor 112.

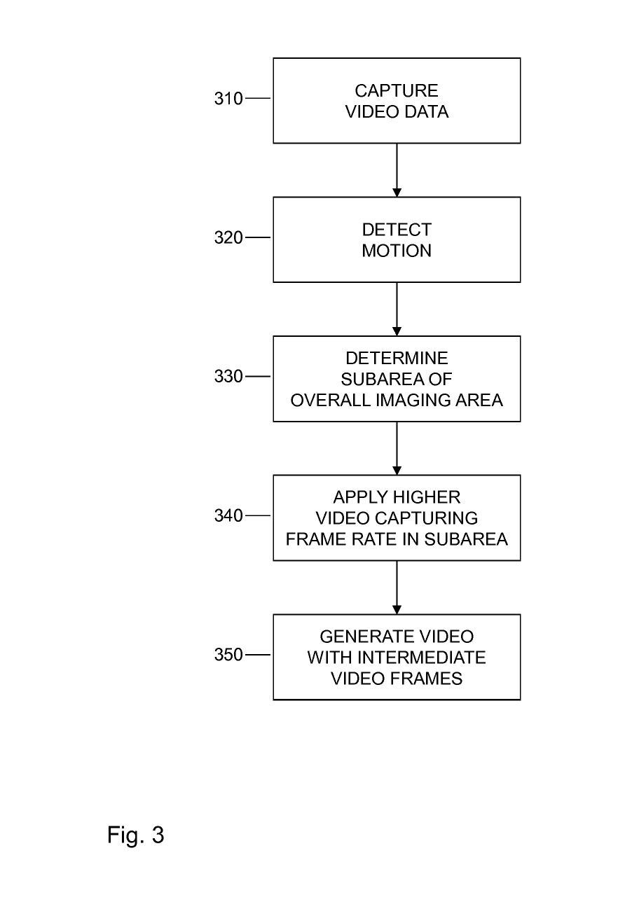

FIG. 3 shows a flowchart which illustrates a method of capturing video. The method may for example be implemented in a device equipped with an imaging sensor, such as the above-mentioned device 100. If a processor based implementation of the device is utilized, at least a part of the steps of the method may be performed and/or controlled by one or more processors of the device.

At step 310, video data is captured by an imaging sensor, such as the imaging sensor 112. The imaging sensor may include a pixel array, such as the pixel array 114. An overall imaging area of the imaging sensor may be defined by such pixel array.

Capturing the video data may involve capturing a first video frame and a second video frame which cover the overall imaging area of the imaging sensor. Capturing the first video frame and the second video frame may be performed at a first video capturing frame rate, e.g., corresponding to the above-mentioned base frame rate. The first video frame and the second video frame may for example correspond to the above-mentioned normal video frames.

Further, capturing the video data may involve capturing a sequence of one or more further video frames in a time interval between capturing the first video frame and the second video frame. The further video frames are captured at a video capturing frame rate which is higher than the video capturing frame rate applied for the first video frame and second video frame. For example, this higher video capturing frame rate may be increased by a factor of at least two, preferably by a factor in a range from five to 50, with respect to the video capturing frame rate applied for the first video frame and second video frame. As compared to the first video frame and the second video frame, the further video frames cover only a subarea of the overall imaging area, such as the above-mentioned subarea 116. Accordingly, irrespective of applying the higher video capturing frame rate, resource utilization may be limited to a sustainable level.

At step 320, motion is detected in the captured video data. This detecting of motion may be based on the one or more further video frames of step 310. However, also the first video frame and/or second video frame may be considered in this detecting of motion. In some scenarios, the detecting of motion may be based on image analysis and comparison processes which are iteratively repeated with each newly captured video frame.

In some scenarios, the detecting of motion may involve identifying at least one moving object represented by the captured video data, such as the moving object 118. Also characteristics of the moving object, such as its shape, and/or characteristics of its movement, such as speed and/or direction of motion, may be identified.

At step 330, at least one subarea of the overall imaging area of the imaging sensor is determined. The subarea is determined to correspond to a position of the detected motion. This may for example involve utilization of the characteristics of a moving object as determined at step 320. For example, the shape, position, and/or speed of motion of the moving object as detected at step 320 may be utilized for predicting a position of the moving object in the overall imaging area when capturing the next video frame and to set the position and/or size of the subarea in a corresponding manner, i.e., in such a way that the moving object is covered by the subarea.

At step 340, the higher video capturing frame rate is applied for the subarea determined at step 330. Accordingly, in the subarea a video capturing frame rate is applied which is higher than in other parts of the overall imaging area.

At step 350, a video may be generated which includes intermediate video frames which are based on video data captured at the higher video capturing frame rate. For this purpose, each of the above-mentioned further video frames may be combined with at least one of the above-mentioned first video frame and second video frame to obtain a corresponding intermediate video frame covering the overall imaging area. For example, this may involve blending video date from the further subframe into the first video frame or second video frame, or into an interpolation of the first video frame and the second video frame. Accordingly, in some scenarios the determining of the subarea may involve, for each of the above-mentioned one or more further subframes, predicting a position of the moving object and determining the subarea to cover the moving object in the respective further subframe. As an alternative to determining the subarea individually for each of the further subframes, it is also possible to predict a position of the moving object and determine the subarea to cover the moving object in all of the further subframes.

In some scenarios, also global motion of the imaging sensor may be detected, e.g., global motion due to a panning movement of the imaging sensor or due to shaking or vibration of the imaging sensor. In response to detecting such global motion of the imaging sensor, the higher video capturing frame rate may be applied in all parts of the overall imaging area. At the same time, a pixel resolution of capturing the video data in the overall imaging area may be reduced. The global motion may be detected on the basis of the captured video data and/or on the basis of one or more motion sensors.

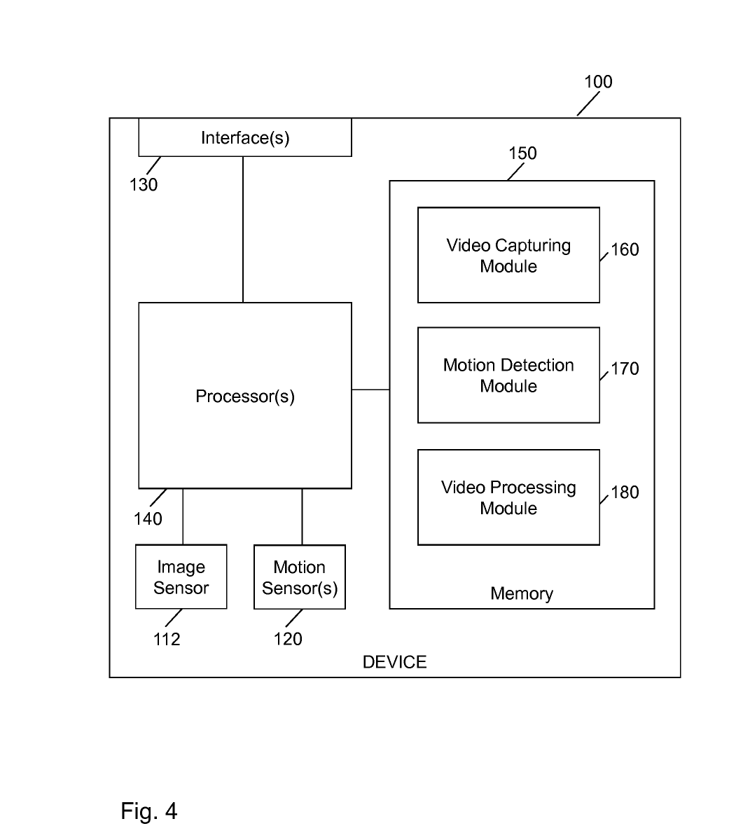

FIG. 4 shows a block diagram for schematically illustrating a processor based implementation of a device which may be utilized for implementing the above-described concepts. For example, the structures as illustrated by FIG. 4 may be utilized to implement the device 100.

As illustrated, the device 100 includes an imaging sensor, such as the imaging sensor 112. Further, the device 100 may include one or more motion sensors 120, such as accelerometers. Further, the device 100 may include one or more interfaces 130. For example, if the device 100 corresponds to a smartphone or similar portable communication device, the interface(s) 130 may include one or more radio interfaces and/or one or more wire-based interfaces for providing network connectivity of the device 100. Examples of radio technologies for implementing such radio interface(s) for example include cellular radio technologies, such as GSM (Global System for Mobile Communications), UMTS (Universal Mobile Telecommunication System), LTE (Long Term Evolution), or CDMA2000, a WLAN (Wireless Local Area Network) technology according to an IEEE 802.11 standard, or a WPAN (Wireless Personal Area Network) technology, such as Bluetooth. Examples of wire-based network technologies for implementing such wire-based interface(s) for example include Ethernet technologies and USB (Universal Serial Bus) technologies.

Further, the device 100 is provided with one or more processors 140 and a memory 150. The imaging sensor 112, the motion sensors 120, the interface(s) 130, and the memory 150 are coupled to the processor(s) 140, e.g., using one or more internal bus systems of the device 100.

The memory 150 includes program code modules 160, 170, 180 with program code to be executed by the processor(s) 140. In the illustrated example, these program code modules include a video capturing module 160, a motion detection module 170, and a video processing module 180.

The video capturing module 160 may implement the above-described functionalities of capturing video data while applying a higher video capturing frame rate in a subarea of the overall imaging area of the imaging sensor 112. Further, the video capturing module 160 may also implement the above-described determination of the subarea in which the higher video capturing frame rate is applied.

The motion detection module 170 may implement the above-described functionalities of detecting motion in the captured video data. Further, the motion detection module may also apply detection of global motion, e.g., on the basis of the captured video data or on the basis of outputs of the motion sensor(s) 120.

The video processing module 180 may implement the above-described functionalities of combining the high rate video frames captured in the subarea with the normal rate video frames captured in the overall imaging area.

It is to be understood that the structures as illustrated in FIG. 4 are merely exemplary and that the device 100 may also include other elements which have not been illustrated, e.g., structures or program code modules for implementing known functionalities of a smartphone, digital camera, or similar device. Examples of such functionalities include communication functionalities, media handling functionalities, or the like.

As can be seen, the concepts as explained above allow for efficiently capturing video data. In particular, a high quality video may be generated with low levels of blurring, even if moving objects are present in the imaged scene. In addition to avoiding blurring, the captured video data may also allow for generating high quality slow motion videos.

It is to be understood that the concepts as explained above are susceptible to various modifications. For example, the concepts could be applied in various kinds of devices, in connection with various kinds of imaging sensor technologies, including array cameras, stereoscopic cameras, or the like. Further, the concepts may be applied with respect to various kinds of video resolutions and frame rates.

1. A method of capturing video, the method comprising:
capturing video data by an imaging sensor;
detecting motion in the captured video data;
determining at least one subarea of an overall imaging area of the imaging sensor which corresponds to a position of the detected motion; and
in the determined subarea, apply a video capturing frame rate which is higher than a video capturing frame rate applied in other parts of the overall imaging area.

2. The method according to claim 1,
wherein said capturing of the video data comprises:
capturing a first video frame and a second video frame which cover the overall imaging area; and
in a time interval between capturing the first video frame and capturing the second video frame, capturing a sequence of one or more further video frames covering only the determined subarea.

3. The method according to claim 2, comprising:
combining each of said one or more further video frames with at least one of the first video frame and the second video frame to a corresponding intermediate video frame covering the overall imaging area.

4. The method according to claim 2,
wherein said detecting of motion is based on the one or more further video frames.

5. The method according to claim 1,
wherein said detecting of motion comprises identifying at least one moving object represented by the captured video data.

6. The method according to claim 5,
wherein said determining of the subarea comprises:
for each of the one or more further subframes, predicting a position of the moving object and determining the subarea to cover the moving object in the respective further subframe.

7. The method according to claim 5,
wherein said determining of the subarea comprises:
predicting a position of the moving object and determining the subarea to cover the moving object in all of the further subframes.

8. The method according to claim 1, comprising:
detecting global motion of the imaging sensor; and
in response to detecting global motion of the imaging sensor, applying the higher video capturing frame rate in all parts of the overall imaging area and reducing a pixel resolution of capturing the video data in the overall imaging area.

9. The method according to claim 1, comprising:
detecting the global motion on the basis of the captured video data and/or on the basis of one or more motion sensors.

10. The method according to claim 1,
wherein the video capturing frame rate applied in the subarea is increased by at least a factor of two with respect to the video capturing frame rate in the other parts of the overall imaging area.

11. A device, comprising:
an imaging sensor; and
at least one processor, the at least one processor being configured to:
capture video data by the imaging sensor;
detect motion on the basis of the captured video data;
determine at least one subarea of an overall imaging area of the imaging sensor which corresponds to a position of the detected motion; and
in the determined subarea, apply a video capturing frame rate which is higher than a video capturing frame rate applied in other parts of the overall imaging area.

12. The device according to claim 11,
wherein the at least one processor is configured to capture the video data by:
capturing a first video frame and a second video frame which cover the overall imaging area; and
in a time interval between capturing the first video frame and capturing the second video frame, capturing a sequence of one or more further video frames covering only the determined subarea.

13. The device according to claim 12,
wherein the at least one processor is configured to combine each of said one or more further video frames with at least one of the first video frame and the second video frame to an corresponding intermediate video frame covering the overall imaging area.

14. The device according to claim 12,
wherein the at least one processor is configured to perform said detecting of motion based on the one or more further video frames.

15. The device according to claim 11,
wherein the at least one processor is configured to perform said detecting of motion by identifying at least one moving object represented by the captured video data.

16. The device according to claim 15,
wherein the at least one processor is configured to perform said determining of the subarea by:
for each of the one or more further subframes, predicting a position of the moving object and determining the subarea to cover the moving object in the respective further subframe.

17. The device according to claim 15,
wherein the at least one processor is configured to perform said determining of the subarea by:
predicting a position of the moving object and determining the subarea to cover the moving object in all of the further subframes.

18. The device according to claim 11,
wherein the at least one processor is configured to:
detect global motion of the imaging sensor; and
in response to detecting global motion of the imaging sensor, apply the higher video capturing frame rate in all parts of the overall imaging area and reduce a pixel resolution of capturing the video data in the overall imaging area.

19. The device according to claim 11,
wherein the at least one processor is configured to detect the global motion on the basis of the captured video data and/or on the basis of one or more motion sensors.

20. The device according to claim 11,
wherein the video capturing frame rate applied in the subarea is increased by at least a factor of two with respect to the video capturing frame rate in the other parts of the overall imaging area.
